(19) United States
(12) Patent Application Publication
(10) Pub. No.: US 2006/0187954 A1
(43) Pub. Date: Aug. 24, 2006

(54) Expandable modular residential gateway

(76) Inventors: Enrico Braschi, Milano (IT); Francesco Simonelli, Milano (IT); Guido Oliveti, Milano (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/537,912

(22) PCT Filed: Dec. 10, 2002
(86) PCT No.: PCT/EP02/13994

§ 371 Date: Feb. 23, 2006

(51) Int. Cl. H04L 12/66

(52) U.S. Cl. 370/463

(57) ABSTRACT

A modular expandable gateway has at least one base module, including a broad-band data communication device for handling communications with an external broad band data communication network, at least one local network port for the connection to a local communication network, a local network interface device adapted to handle communications with the local data communication network and coupled to the local network port through a local network communication bus, the local network interface having a media independent interface and a disable input, a data processing unit interacting with the broad-band data communication device and, through a media independent interface bus connected to the media independent interface, with the local network interface device, so as to enable intercommunication between the local network and the external network; a disable signal line coupled to the disable input of the local network interface device and adapted to drive the local network interface device into a disabled state in which the local network interface device does not engage the media independent interface bus and the local network port, and expansion bus allowing expandability of the gateway by connecting at least one expansion module to the base module, and having the media independent interface bus, the local network communication bus and the disable signal line.

The present invention generally relates to devices enabling users to access external data communication networks such as the Internet, and more specifically to a gateway, particularly but non-limitatively intended for the use in residential environments, such as houses and small-office/home-office (SOHO) environments.

The deployment of broad-band data communications to residential environments is one of the main objectives currently pursued by telecom companies. The technology enabling access of user appliances, typically personal computers, to data communication networks, starting from analog MODEMs that allowed relatively low speed data communication over the public switched telephone network (PSTN), has been driven by the fast diffusion of the Internet to evolve towards more powerful solutions. In particular, the introduction of integrated service digital network (ISDN) and, even more, digital subscriber line (DSL) technologies, such as ADSL, SDSL, HDSL and VDSL (globally referred to as xDSL technologies) has significantly increased the communication bandwidth, making it possible to offer new high value services to the users. Nowadays, a step forward in the increase in the communication bandwidth is expected from the deployment of fiber optic communications to the user premises.

In parallel to the above described phenomenon, local data communication networks, once restricted to large entities, have started to become popular also in relatively small environments, and particularly in residential environments. Especially in SOHO environments, small local data communication networks are useful, because they allow interconnecting personal computers, printers and similar devices. These small local data communication networks are mainly Ethernet-based networks, but several other technologies exist, for example homePNA, Bluetooth™, power line transmission, just to cite some.

It is therefore desirable to have a device that acts as a residential gateway, allowing interconnecting one or more different user appliances, particularly in a user local network, and enabling access to an external communication network such as the Internet.

A problem in developing residential gateway devices resides in the breadth of different local network technologies and access technologies to external broad-band communication networks. Developing a residential gateway selecting specific local network and external network access technologies that, at the moment, seem to be the most popular, may cause the device to quickly become obsolete. On the other hand, implementing all, or at least the more popular existing technologies in a single device is not a feasible approach, at least from the cost viewpoint. Considering the market target for these gateway devices, low price is considered essential to make them attractive; in particular, the user may be discouraged from spending a considerable amount of money for purchasing functions that, at least at the beginning, he/she does not foresee to exploit. Other important considerations are physical dimensions, which should be small, and ease of use. In any case, the rapid evolution of networking and access technologies would inevitably cause even the more complete and up-to-date device to become obsolete more or less rapidly.

Residential gateways having a modular structure have been proposed. The modular structure allows the user to buy a device in a base configuration, sold at relatively low price; the device functions can be successively expanded, depending on the needs, by adding new components, which the manufacturer can develop at different time, to keep pace with the technological evolution.

Some known modular residential gateways have a fixed-size enclosure capable of housing a predetermined number of expansion components that the user can purchase at different times.

The drawbacks of this solution are that the gateway enclosure needs to be relatively bulky, and installing expansion components is not straightforward for the user. Additionally, the initial cost may be unacceptably high for the user, especially if the need of expanding the structure is not initially foreseen. Moreover, only a limited number of expansion components can be installed, which limit the possibility of expanding the gateway.

A better solution is proposed in US 2002/0065935. In this document, a modular residential gateway is disclosed having a modular design according to which, starting from a base configuration comprised of two stacked modules, additional modules can be stacked up as desired by the user, to expand the gateway functions. One of the two modules is a power supply module, providing the power for the stack of modules.

The Applicant has also observed that modular gateway designs which require more or less extensive re-wiring when additional modules are added may discourage the users. In particular, this may happen when modules are added to an existing gateway configuration in order to expand the local networking capability: the user should not, as far as possible, be required to unplug local network devices, such as personal computers and the like, from the existing gateway and to plug-in again these devices in a new configuration.

In view of the state of the art outlined, it has been an object of the present invention to provide a modular apparatus, such as a gateway, particularly but non-limitatively adapted to the use in residential environments.

In particular, it has been an object of the present invention to provide a modular apparatus for data communication between an external data network and a local data network, e.g. a gateway, that has a reasonably low cost, is easy to expand and does not require extensive re-wiring when additional modules are added to an existing configuration of the apparatus.

According to an aspect of the present invention, a modular expandable apparatus as set forth in claim 1 is provided.

Briefly stated, the modular expandable apparatus comprises at least one base module, including:

a broad-band data communication device for handling communications with an external data communication network through a broad-band data communication channel;

at least one local network port for the connection to a local data communication network;

a local network interface device adapted to handling communications with the local data communication network and coupled to the local network port through a local network communication bus, the local network interface having a media independent interface and a disable input;

a data processing unit interacting with the broad-band data communication device and interacting with the local network interface device through a media independent interface bus connected to the media independent interface thereof, for enabling intercommunication between the local network and the external network;

a disable signal sine coupled to the disable input of the local network interface device and adapted to drive the local network interface device into a disabled state in which the local network, interface device does not engage the media independent interface bus and the local network port;

an expansion bus allowing expandability of the apparatus by connecting at least one expansion module to the base module, the expansion bus comprising the media independent interface bus, the local network communication bus and the disable signal line.

In the context of the present invention, and referring to the Open System Interconnection (OSI) standard by ISO, by media independent interface, and media independent interface bus, there is generally intended an interface, respectively a bus of signal lines, enabling a Media Access Control (MAC) engine to interact with a physical layer device. Media independent interfaces and media independent interface buses are normally defined in the network standards, such as for example the parallel, full-duplex media independent interfaces and media independent interface buses defined for Ethernet, Fast Ethernet and Gigabit Ethernet, and the serial media independent interface and media independent interface bus for Serial Network Interface (SNI).

An expansion module that includes an expansion local network interface device having a media independent interface, once connected to the expansion bus, is thus allowed to:

disable the local network interface device of the base module by driving the disable signal line;

exploit the media independent interface bus for interacting with the data processing unit of the base module; and

exploit the local network communication bus for communicating over the local network through the local network port of the base module.

In the following, reference wail be made nil particular to examples and embodiments of the invention in a gateway, i.e., an apparatus that performs a protocol conversion between two dissimilar networks. However, the invention can be also applied to devices other than a gateway such as, for example, bridges or routers, that allow communication between networks using a same protocol.

In an embodiment of the present invention, the local network is an Ethernet network, and the local network interface device comprises an Ethernet physical layer transceiver.

The broad-band data communication device is for example an xDSL data communication device, and is implemented by the data processing unit.

In a preferred embodiment of the present invention, the base module further comprises a data processing unit bus connected to the data processing unit, and which is part of the expansion bus. Access to the expansion bus may for example be allowed by at least one expansion connector.

In addition to the base module, the modular expandable apparatus may comprise at least one expansion module, comprising at least one input expansion connector matching the expansion connector of the base module.

The at least one expansion module preferably further comprises an output expansion connector matching the input expansion connector, thereby allowing connection of further expansion modules.

In a first type of expansion module, the data processing unit bus, the media independent interface bus, the local network communication bus and the disable line are propagated from the input expansion connector to the output expansion connector of the expansion module.

In a second type of expansion module, the data processing unit bus is propagated from the input expansion connector to the output expansion connector of the expansion module, while the media independent interface bus, the local network communication bus and the disable line are not propagated to the output expansion connector.

An expansion module of the second type may include an Ethernet switch. Preferably, the Ethernet switch comprises a media independent interface which, when the input expansion connector of the expansion module is connected to expansion connector of the base module, interacts with the data processing unit through the media independent interface bus of the expansion bus. The expansion module preferably drives the disable line to a disable state for disabling the local network interface device of the base module.

The Ethernet switch preferably comprises:

at least one first Ethernet port connected to a respective local network connector through a respective first local network communication bus;

a second Ethernet port connected through a second local network communication bus to the input expansion connector, for the connection to the local network communication bus of the expansion bus; and

a third Ethernet port connected through a third local network communication bus to the output expansion connector.

The Ethernet switch may also include at least one optical Ethernet port, connected through a respective optical Ethernet communication bus to an optical transceiver of the expansion module.

Several different expansion modules may be envisaged. For example, an expansion module may be a wireless local area network expansion module, adapted to allow wireless communication, or a power line transmission expansion module adapted to allow communication over an AC power line.

In a preferred embodiment of the present invention, the base module comprises a power supply input for receiving an unregulated power supply and at least one first power supply regulator for generating a first regulated power supply from the unregulated power supply; the first regulated power supply supplies the data processing unit and the local network interface device. The expansion bus comprises unregulated power supply distribution lines, and the at least one expansion module comprises at least one respective second power supply regulator generating a second regulated power supply from the unregulated power supply.

According to another aspect of the present invention, there is provided a method, as set forth in claim 19, of expanding a modular apparatus adapted to allow intercommunication between a local data communication network and an external data communication network.

The modular apparatus comprises a base module:

a broad-band data communication device for handling communications with the external data communication network through a broad-band data communication channel;

at least one local network port for the connection to a local data communication network;

a local network interface device adapted to handling communications with the local data communication network and coupled to the local network port, the local network interface device having a media independent interface; and

a data processing unit interacting with the broad-band data communication device and interacting with the media independent interface of the local network interface device, for enabling intercommunication between the local network and the external network.

The method comprises:

coupling to the base module at least one expansion module including at least one expansion local network port for the connection to the local data communication network, and an expansion local network interface device coupled to the expansion local network ports and having a medic independent interface;

disabling the local network interface device of the base module;

controlling the expansion local network interface device by means of the data processing unit of the base module through the media independent interface of the expansion local network interface device; and

coupling the at least one local network port of the base module to the expansion local network interface device.

According to still another aspect of the present invention, an expansion module for the modular expandable apparatus is provided as set forth in claim 20.

The expansion module comprises an expansion local network interface device adapted to handling communications with the local data communication network, the expansion local network interface device having an expansion media independent interface; an expansion media independent interface bus connected to the expansion media independent interface; an expansion local network communication bus connected to the expansion local network interface device.

An expansion bus connection scheme is provided for the connection of the expansion module to the expansion bus; the expansion bus connection scheme is adapted to:

connect the expansion media independent interface bus to the media independent interface bus;

connect the expansion local network communication bus to the local network communication bus, and

drive the disable signal line to a state corresponding to a disabled state of the local network interface device.

The features and advantages of the present invention will be made apparent by the following detailed description of an embodiment thereof, provided merely by way of non-limiting example, made in connection with the attached drawing sheets, wherein:

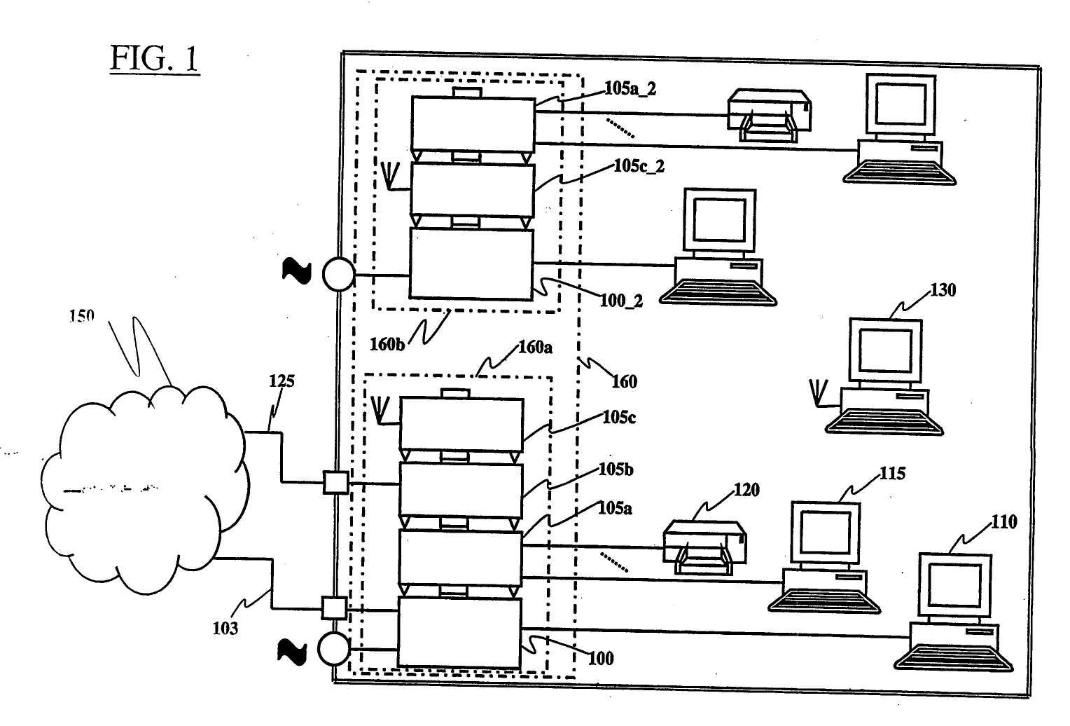

FIG. 1 schematically, shows a modular gateway structure according to an embodiment of the present invention;

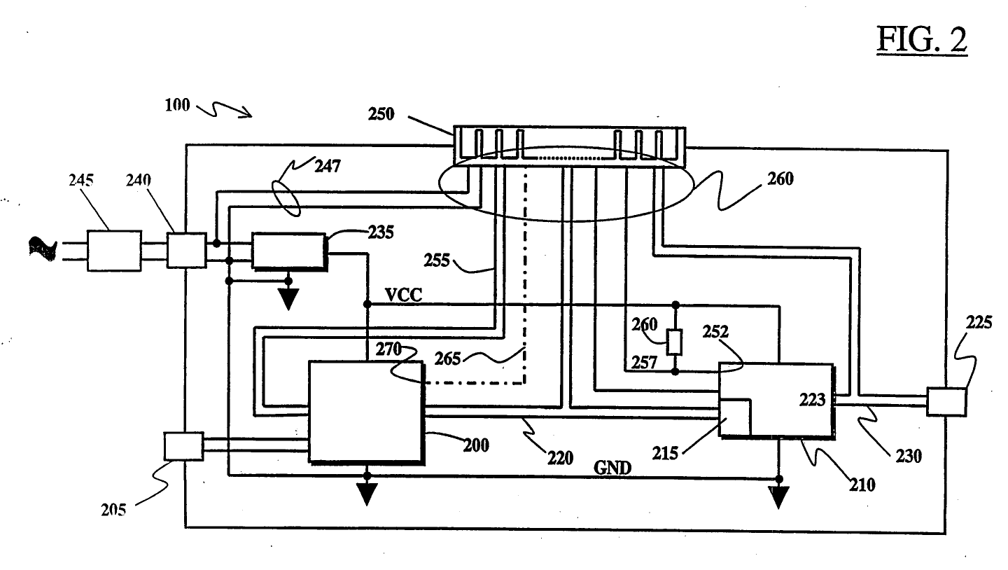

FIG. 2 schematically shows a base module of the modular gateway, according to an embodiment of the present invention;

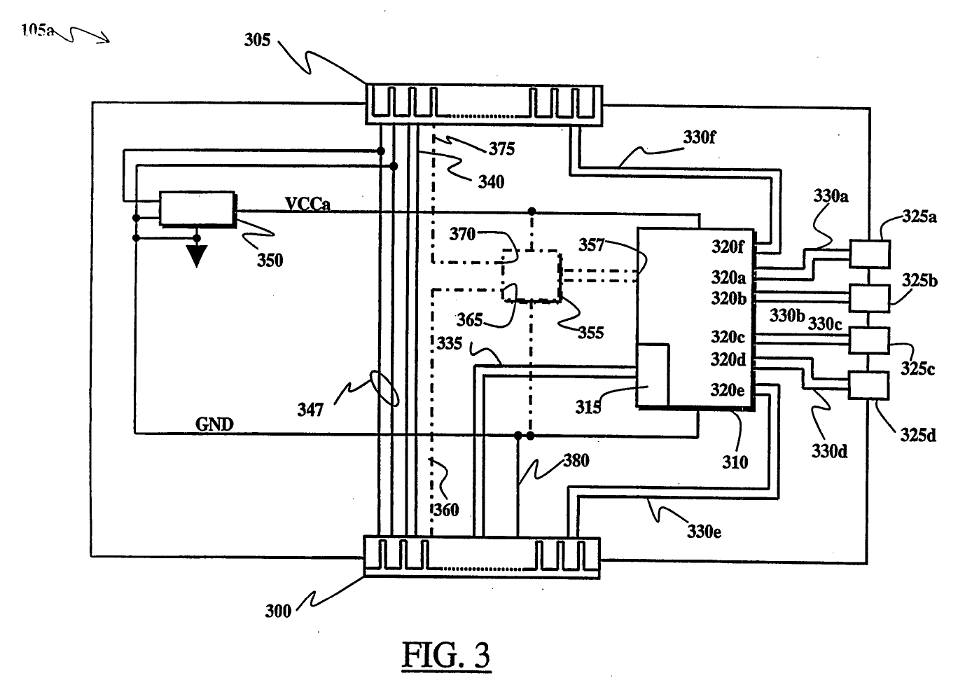

FIG. 3 schematically shows a first type of expansion module of the modular gateway, according to an embodiment of the present invention;

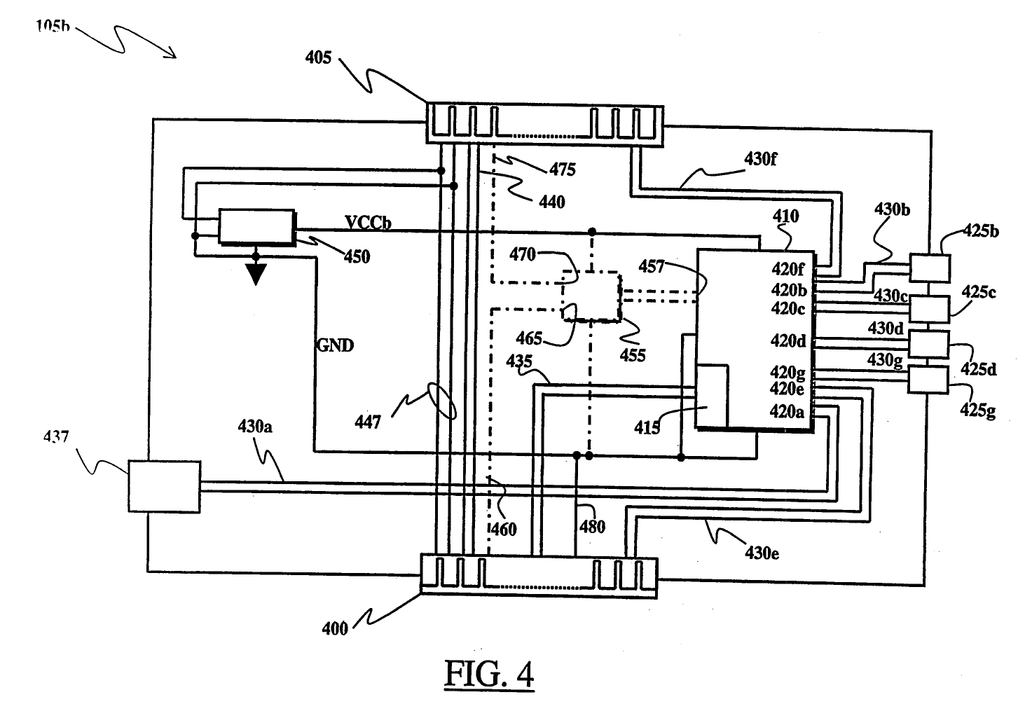

FIG. 4 schematically shows a second type of expansion module of the modular gateway, according to an embodiment of the present invention;

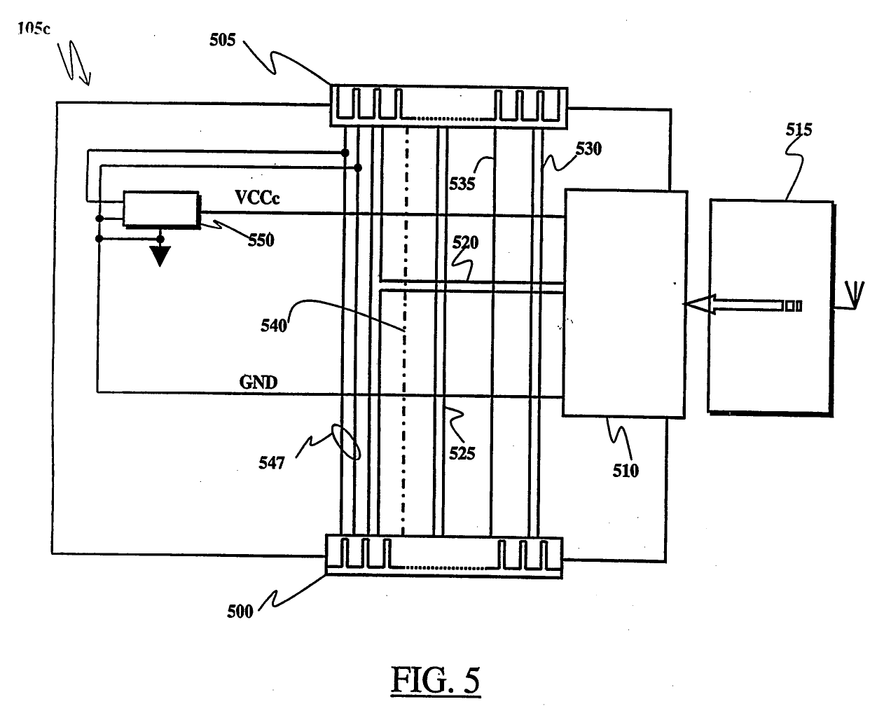

FIG. 5 schematically shows a third type of expansion module of the modular gateway, according to an embodiment of the present invention.

With reference to the drawings, in FIG. 1 a modular gateway structure according to an embodiment of the present invention is schematically shown.

The gateway, particularly but non-limitatively adapted for residential use (home or SOHO environments), enables access to an external data communication network, depicted only schematically and identified by 150, typically a metropolitan area network (MAN) or a wide area network (WAN), for example the Internet.

The gateway, globally identified as 160, has a modular structure that allows expanding the gateway functions according to the user's needs; in particular, the gateway 160 is composed of modules mechanically and electrically interconnected to each other. The gateway 160 does not have a fixed-size enclosure; each of the modules comprises a housing of any desired shape, and the overall physical dimension of the gateway increases with the number of modules that are added.

The gateway 360 comprises a base module 300, providing basic gateway functions. In particular, the base module 300 enables access to the external data communication network 150 over a prescribed communication channel 303, preferably a broad-band channel of the xDSL family, for example an ADSL communication channel; in addition, the base module 100 also allows connection to a user network device, for example a personal computer 110 equipped with a network adapter, particularly an Ethernet network adapter, or to an already existing data communication network local to the user environment, in particular an Ethernet network; for example, the base module 100 can be connected to a port of a local network hub, switch or router (not shown in the drawing) already installed in the user residential environment.

At least the base module 100 must be present. The base module 100 alone already enables the user to access the external network 150, through the communication channel 103.

One or more expansion modules can optionally be associated with the base module 100, in order to expand the gateway functions; by way of example, in FIG. 1 three expansion modules 105a, 105b, 105c are shown as connected to the base module 100. In particular, in an exemplary embodiment of the present invention, the expansion module 105a performs the function of local (electrical or optical) network hub, switch or router, increasing the number of local network ports of the gateway 160 and allowing connecting additional user network devices to the local network, such as additional personal computers 115, network printers 120 and the like. The expansion module 105b enables access to the external data communication network 150 (or to a different external data communication network) over a communication channel 125 different from the ADSL communication channel 103, for example an optical communication channel. Preferably, the communication channel 125 has a broader bandwidth than the basic communication channel 103, and the expansion module 105b is for example added to the base module 100 to replace the slower communication channel 103 with the faster communication channel 125.

The expansion module 105c allows wireless communication of the gateway 160 with user appliances installed in the user environment, for example a personal computer 130; the expansion module 105c also allows connecting the gateway 160 to an already existing wireless local network, or setting up a wireless local network, local to the user environment. It is intended that the number and kind of expansion modules may vary, depending on the user needs and the development of local networking and external network access technologies. A more complete, although still not exhaustive, list of types of expansion modules will be provided hereinafter.

In an embodiment of the present invention, not at all limitative, the expansion modules are piled up on the base module, to form a stack; the stacking of modules can be vertical or horizontal. Each expansion module is thus connected to a preceding module in the stack; the preceding module in the stack can be either the base module, in the case the expansion module is the first module added to the base module, or a preceding expansion module in the stack; additional expansion modules can be at any time stacked up on an already existing stack of modules. However, it is intended that the way in which the modules are interconnected, and the resulting physical shape of the gateway are not limitative to the present invention.

Moreover, as schematically shown in FIG. 1, the modular gateway is not restricted to be physically positioned in a unique location within the user premises. Particular expansion modules may be devised, such as for example the wireless expansion module 105c, that allow splitting the gateway in two or more stacks, physically located in different places; referring to the example shown in FIG. 1, a first stack 160a, comprised of the base module 100 and the three expansion modules 105a, 105B, 105c, is placed in a first physical location, and a second stack 160b, comprised of an additional base module 100_2, identical to the base module 100, a wireless expansion module 105c_2, identical to the wireless module 105c, and a local network hub, switch or router expansion module 105a_2, identical to the module 105a, is placed in a second physical location within the user premises. Communication between the modules in the two stacks 160a, 160b is in this exemplary case made possible by the wireless modules 105c and 105c-2. Other types of expansion modules can be designed that allow a similar splitting of the gateway, for example power line transmission (PLT) expansion modules enabling communication over the AC power lines within the user premises.

FIG. 2 shows, still schematically but in greater detail, the internal structure of the gateway base module 100, in an embodiment of the present invention. The base module 100 comprises a data processing unit 200, particularly a microprocessor with suitable RAM and ROM resources (not shown in the drawing). The data processing unit 200 in the base module 100 constitutes the central processing unit of the whole gateway. The data processing unit 200 is connected to a connector 205, accessible from outside the housing of the base module 100, for the connection of the base module 100 to the ADSL communication channel 103; in particular, the connector 205 is an RJ11 or an RJ45 connector, and can be connected to a telephone socket through a common telephone cable. The data processing unit 200 is intended to be capable of performing the functions of ADSL controller, for handling the communication over the ADSL communication channel 103. A commercially-available component suitable to be used as data processing unit 200 is the home network processor (HNP) CX82310 by Conexant.

The base module 100 also comprises a physical layer transceiver 210, handling the communication over the user local Ethernet network. In particular, the physical layer transceiver 210 includes a standard media independent interface (MII) 215; the physical layer transceiver 210 communicates with the data processing unit 200 through the MII 215 and a standard bus 220 of signal lines (MII bus). The signals of the MII bus 220 are specified in the IEEE standard for Ethernet-based protocols; for example, the IEEE Standard Specification 802.3u for the Fast Ethernet protocol (communication speeds up to 100 Nbit/sec) specifies that the MII bus comprises eighteen signals, namely: TXD[0:3], TX_ER, TX-CLK, TX_EN, CRS, COL, MDIO, MDC, RXD[0:3], RX_ER, RX_DV, RX_CLK; as another example, the IEEE Standard Specification 802.3z for the Gigabit Ethernet protocol (communication speeds up to 1 Gbit/sec) specifies that the MII bus comprises twenty-eight signals, namely: TXD[0:7], TX_ER, TX_CLK, TX_EN, TX-CTRL, CRS, COL, MDIO, MDC, RXD[0:7], RX_ER, RX_DV, RX_CLK, RX_CTRL. The meaning of the signals making up the MII bus is well known to those skilled in the art, and will not be discussed in further detail.

The data processing unit 200 implements a media access control (MAC) layer and, if necessary, higher layers of the ISO open system interconnect (OSI) stack; the MAC layer implemented by the data processing unit 200 communicates with the physical layer transceiver 210 via the MII bus 220 and the MII 215.

A commercially-available component suitable to be used as physical layer transceiver 210 is for example the KS8737 or the KS8721, both by Kendin Communications, the DM9131, the DM9163 or the DM9162 by Davicom, the LXT971A or the LXT972A, both by Intel.

It is pointed out that, more generally, the MII 215 and the MII bus 220 can be any interface and interface bus allowing a MAC layer to interact with a physical layer. The MII and the MII bus can be either full-duplex (as the two MIIs mentioned above) or half-duplex, as well as parallel or serial.

The physical layer transceiver 210 has an Ethernet port 223, connected to a connector 225 accessible from outside the housing of the base module 100, for example an RJ45 connector, for the connection of the base module 100 to the local Ethernet network. In particular, the physical layer transceiver 210 is connected to the connector 225 through a bus 230 of Ethernet signal lines, particularly a 10/100BaseTX bus, comprising four signal lines, two (TX+, TX−) for serially transmitting data and two (RX+, RX−) for serially receiving data to/from the local Ethernet network; alternatively, the bus 230 may be a Gigabit Ethernet bus. Through the connector 225 and a common cable connection, the base module 100 can be connected, to a user network device, for example a personal computer equipped with an Ethernet network adapter, or, in case a local Ethernet network already exists, to an external Ethernet hub, switch or router.

The base module 100 additionally comprises a supply voltage regulator 235, receiving a non-regulated supply voltage through a plug 240, accessible from outside the housing of the base module, to which an external power supply 245 can be connected. The external power supply 245 is for example plugged into an AC power line socket, and comprises a transformer and a rectifier, for generating a specified unregulated DC voltage, e.g. 12 V, starting from the AC voltage received from the AC power line. The supply voltage regulator 235 receives the unregulated supply voltage from the external power supply in through a pair 247 of voltage supply lines, and generates a regulated output voltage of prescribed value, e.g. 5 V or 3 V; the regulated voltage is distributed to the components of the base module 100, particularly the data processing unit 200 and the physical layer transceiver 210, through a supply voltage rail VCC; a reference voltage or ground rail GND is connected to one of the pair of voltage supply lines 247, and distributes a reference voltage to the components of the base module.

The physical layer transceiver 210 can be selectively enabled/disabled; when disabled, outputs of the physical layer transceiver 210 on the side of the MII bus and the Ethernet port 223 are kept in a high-impedance condition. For example, in order to enable the physical layer transceiver 210, an enable input 252 thereof is to be kept at a prescribed voltage level, for example corresponding to the regulated supply voltage. The enable input 252 is connected to an enable/disable line 257, connected to the supply voltage rail VCC through a pull-up element 260; in this way, the physical layer transceiver 210 is normally kept enabled.

The base module 100 further comprises an expansion connector 250, accessible from outside the base module housing, for enabling the electrical connection of an expansion module to the base module. In particular, the expansion connector 250 is a male connector; alternatively, the expansion connector 250 may be a female connector. Through the expansion connector 250, an expansion bus 260 of signal lines is made available to the generic expansion module than is or can be connected to the base module 100. In the exemplary embodiment of the invention described herein, the expansion bus 260 includes:

signals of a bus 255 of the data processing unit 200, including address signals, data signals and control signals, for communicating with peripheral devices;

the signals of the MII bus 220;

the signals of the 10/100BaseTX Ethernet bus 230;

the physical layer transceiver enable/disable line 257; and

the pair of lines 247 carrying the unregulated supply voltage supplied by the external power supply 245.

Optionally, the expansion bus 260 also includes a bi-directional serial communication line 265 connected to a port 270 of the microprocessor 200 intended to act as a serial bi-directional communication port.

A prescribed pin assignment scheme is followed in connecting the lines of the expansion bus 260 to the pins of the expansion connector 250. For example, starting from the first connector pin, a first group of pins (e.g., pins #1 to #40) is assigned to the signal lines of the microprocessor bus 255, a second group of pins (e.g., pins #41 to #59) is assigned to the signal lines of the MII bus 220, a third group of pins (e.g., pins #60 to #63) is assigned to the signal lines of the 10/100Base TX Ethernet bus 230, a fourth group of pins (in this example including one pin, e.g. pin #64) is assigned to the enable/disable line 255, and a fifth group of pins (e.g., pins #65 and #66) is assigned to the lines 247 carrying the unregulated supply voltage; if provided, the bi-directional serial communication line 265 is assigned to a sixth group of pins (including one pin) of the expansion connector (e.g., pin #67).

It is observed that although in this embodiment of the invention a single expansion connector is provided for making available the expansion bus 260 to expansion modules, the expansion connector may be made up of more than one distinct physical connectors, each one making available to the expansion modules a respective subset of the above-mentioned signals of the expansion bus 260.

In general, each expansion module has an input expansion connector and an output expansion connector, both accessible from outside the expansion module housing. The input expansion connector of any expansion module matches the expansion connector of the base module, and the output expansion connector matches the input expansion connector. In this way, through the respective input expansion connector, any expansion module can thus be connected directly to the expansion connector 250 of the base module 100, or, if one or more expansion modules have already been stacked up onto the base module 100, the additional expansion module can be connected to the output expansion connector of the last expansion module of the stack. Additionally, the input expansion connector and the output expansion connector in every expansion module follow the same pin assignment scheme as the expansion connector 250 of the base module: starting from the first pin, the first group of pins (e.g., pins #1 to #40) is reserved to the signal lines of the microprocessor bus 255, the second group of pins (e.g., pins #41 to #59) is reserved to the signal lines of the MII bus 220, the third group of pins (e.g., pins #60 to #63) is reserved to the signal lines of a 10/100BaseTX Ethernet bus, the fourth group of pins (in this example including one pin, e.g. pin #64) is reserved to the enable/disable line 255, and the fifth group of pins (e.g., pins #65 and #66) is reserved to the lines carrying the unregulated supply voltage; a sixth group of pins (in the example including one pin, e.g., pin #67) is reserved to the bi-directional serial communication line 265, if provided. In the exemplary embodiment of the invention described herein, the input expansion connector is a female connector, and the output expansion connector is a male connector.

It is, observed that expansion modules having only the input expansion connector, and no output expansion connector, can also be envisaged: such expansion modules do not allow further expansion modules to be connected thereto, and shall always be put on top of the stack of gateway modules.

A detailed description of a few types of expansion modules that can be added to the base module 100 will be now provided, being intended that several other types of expansion modules can be designed.

Making reference to FIG. 3, a first type of expansion module 105a according to an embodiment of the present invention is schematically shown. In particular, as already mentioned in the foregoing, the expansion module 105a is intended to perform the functions of an Ethernet switch, which the user can add to the base module 100 for expanding the number of Ethernet ports of the gateway.

In the drawing, the input expansion connector and the output expansion connector are identified by reference numerals 300 and 305, respectively. The input expansion connector 300 allows connecting the expansion module 105a to the expansion connector 250 of the base module 100, or to the output expansion connector of another expansion module already present in the stack of gateway modules. The output expansion connector 305 allows connecting an additional expansion module, of any type, to the expansion module 105a.

The expansion module 105a comprises an Ethernet switch 310, for example a seven-way switch; a suitable commercially available component is for example the KS8999 by Kendin Communications, which is a nine-way switch. The Ethernet switch 310 includes an MII 315, connected through a standard MII bus 335 to the second group of pins of the input expansion connector 300. In this way, when the expansion module 105a is connected to the base module 100, the MII 315 of the switch 310 can communicate with the data processing unit 200 of the base module 100 over the MII signal line buses 335 and 220.

The Ethernet switch 310 has, in this exemplary embodiment, six Ethernet ports (this means that if for example the Kendin KS8999 is used, two Ethernet ports are not exploited). Four Ethernet ports 320a, 320b, 320c, 320d are accessible from outside the housing of the expansion module 105a, through respective connectors 325a, 325b, 325c, 325d, for example of the RJ45 type, each one connected to the respective Ethernet port through a respective four-line 10/100BaseTX Ethernet bus 330a, 330b, 330c, 330d. User network appliances, such as personal computers, printers, already-installed Ethernet hubs, switches or routers can be cable-connected to any one of the connectors 325a, 325b, 325c, 325d.

A fifth Ethernet port 320e is connected, through a 10/100BaseTX Ethernet bus 330e, to the third group of pins of the input expansion connector 300.

A sixth Ethernet port 320f is connected, through a 10/100BaseTX Ethernet bus 330f, to the third group of pins of the output expansion connector 305; in this way, the sixth Ethernet port 320f is made accessible to further expansion modules.

It is pointed out that the buses 330a, 330b, 330c and 330d may also be Gigabit Ethernet buses.

Moreover, one or more of the Ethernet ports 320a, 320b, 320c, 320d of module 105a can be optical, so that the module can form the basis of an optical LAN. In this case, the optical port or ports can be connected, e.g. through one or more 100BaseFX Ethernet bus, to corresponding appropriate transceivers.

Additionally, the fourth group of pins of the input expansion connector 300, in this example made up of a single pin, reserved to the enable/disable line 257 for controlling the enabled/disabled state of the physical layer transceiver 210 in the base module 100, is connected through a line 380 to the ground voltage GND. In this way, when the expansion module 105a is connected to the base module 100, the expansion module 105a disables the physical layer transceiver 210 of the base module 100, so that no conflict arises between the switch 310 and the physical layer transceiver 210; the data processing unit 200 of the base module 100 controls, through the MII signal line buses 220 and 335 and the MII interface 315, the Ethernet switch 310, and the Ethernet port 320e of the Ethernet switch 310 is accessible through the RJ45 connector 225 of the base module 100 and the 10/100BaseTX Ethernet buses 230 and 330e. Thanks to this, after having installed the expansion module 105a, the user is not required to unplug a user network device previously connected to the RJ45 connector 225 of the base module 100: in a way totally transparent to the user, the RJ45 connector 225 becomes one of the plug-in ports of the Ethernet switch 310.

A pair of lines 347 is connected to the fifth group of pins of the input expansion connector 300 and to the fifth group of pins of the output expansion connector 305. The unregulated supply voltage, received from the base module or from an expansion module already present in the stack of gateway modules, is thus made available to further expansion modules. The unregulated supply voltage received through the pair of lines 347 is fed to a voltage regulator 350, generating a regulated supply voltage (e.g., 3 V or 5 V) distributed to the components of the expansion module 105a through a supply voltage rail VCCa. The voltage regulator 350 can be equal to or different from the voltage regulator 235 of the base module, and the regulated supply voltage in the two modules be equal or different, depending on the requirements of the components present in the expansion module 105a.

The microprocessor bus 255 is not exploited by the components of the expansion module 105a, and is simply passed through the expansion module 105a, by means of a bus 340 of a suitable number of signal lines, connected to the first group of pins of the input expansion connector 300 and to first group of pins of the output expansion connector 305; the microprocessor bus 255 is thus made available to further expansion modules through the output expansion connector 305.

It can be appreciated that the output expansion connector 305 of the expansion module 105a propagates and makes thus available to further expansion modules:

the unregulated supply voltage, coming from the base module;

the microprocessor bus 255, coming from the base module;

the 10/100BaseTX Ethernet bus 330f, connected to the Ethernet port 320f of the Ethernet switch 310 of the expansion module 105a.

The MII bus 220 and the enable/disable line 257 for enabling/disabling the physical layer transceiver 210, coming from the base module, stop at the level of the expansion module 105a, and are not propagated to further expansion modules; the corresponding pins of the output expansion connector 305 are left unconnected.

Optionally, a low computing power microcontroller 355 may be provided in the expansion module 105a for locally managing the switch 310 through a management port 357 thereof. If provided, the microcontroller 355 may communicate with the data processing unit 200 of the base module through the bi-directional serial communication line 265; in this case, a first bi-directional serial communication line 360 connects a first bi-directional serial communication port 365 of the microcontroller 355 to the sixth group of pins (pin #67) of the input expansion connector 300. The data processing unit 200 in the base module 100 can thus communicate with, coordinate and control the microcontroller 355 in the expansion module 105a. In order to propagate the bi-directional serial communication channel to further expansion modules, a second bi-directional serial communication port 370 of the microcontroller 355 is connected, through a second bi-directional serial communication line 375, to the sixth group of pins (pin #67) of the output expansion connector 305.

It is observed that similar considerations apply if the expansion module 105a comprises a switch 310 with a different number or Ethernet ports, or the switch 310 is replaced by an Ethernet hub or an Ethernet router.

In FIG. 4, the structure of a second type of expansion module 105b according to an embodiment of the present invention is shown. In particular, as mentioned hereinbefore, the expansion module 105b is intended to enable access of the gateway 160 to the external data communication network 150, or to a different external network, over an optical communication channel, or to a local optical data communication network; at the same time, the expansion module 105b according to this embodiment of the invention performs functions of Ethernet switch, similarly to the expansion module 105a described before, allowing to increase the number of Ethernet ports of the gateway.

The input expansion connector and the output expansion connector of the expansion module 105b are identified by reference numerals 400 and 405, respectively.

The expansion module 105b comprises an Ethernet switch 410, for example an eight-way switch having six Ethernet ports; a suitable commercially available component is for example the already cited KS8999 by Kendin Communications. The Ethernet switch 410 includes a standard MII interface 415, connected through a standard MII bus 435 to the second group of pins of the input expansion connector 400.

At least one port 420a of the Ethernet switch 410 is configurable for optical communications. The optical Ethernet port 420a is connected, through a 100BaseFX Ethernet connection bus 430a, to an optical small form factor (SFF) transceiver 437, a connector of the transceiver 437 being accessible from outside the housing of the expansion module 105b for the connection of the expansion module 105b to a socket of an optical data communication channel.

Four of the remaining Ethernet ports 420b, 420c, 420d and 420g are accessible from outside the housing of the expansion module 105b, through respective connectors 425b, 425c, 425d and 425g, for example of the RJ45 type, each one connected to the respective Ethernet port through a respective 10/100BaseTX Ethernet connection bus 430b, 430c, 430d and 430g.

A fifth Ethernet port 420e is connected, through a 10/100BaseTX Ethernet connection bus 430e, to the third group of pins of the input expansion connector 400.

A sixth Ethernet port 420f is made available to further expansion modules, through a respective 10/100BaseTX Ethernet connection bus 430f connected to the third group of pins of the output expansion connector 405.

The Ethernet buses may alternatively be Gigabit Ethernet buses.

It is also remarked that one or more of the Ethernet ports 420b, 420c, 420d, 420g can be optical, so that the module can form the basis of an optical LAN. In this case, the optical port or ports can be connected, e.g. through one or more 100BaseFX Ethernet bus, to corresponding appropriate transceivers.

Similarly to the expansion module 105a, the fourth group of pins of the input expansion connector 400, in this example made up of a single pin, assigned to the enable/disable line 257 for controlling the enabled/disabled state of the physical layer transceiver 210 in the base module 100, is connected through a line 480 to the ground voltage GND. In this way, when the expansion module 105b is connected to the base module 100, the expansion module 105b disables the physical layer transceiver 210 of the base module 100, so that no conflict arises between the switch 410 and the physical layer transceiver 210; the data processing unit 200 of the base module 100 controls, through the MII buses 220 and 435 and the MII interface 415, the Ethernet switch 410, and the Ethernet port 420e of the Ethernet switch 410 is accessible through the RJ45 connector 225 of the base module 100.

A pair of lines 447 is connected to the fifth group of pins of the input expansion connector 400 and to the fifth group of pins of the output expansion connector 405. The unregulated supply voltage, received from the base module 100, is thus made available to further expansion modules. The unregulated supply voltage carried by the pair of lines 447 is fed to a voltage regulator 450, generating a regulated supply voltage (e.g., 3 V or 5 V) distributed to the components of the expansion module 105a through a supply voltage rail VCCb. The voltage regulator 450 can be equal to or different from the voltage regulator 235 of the base module, and the regulated supply voltage in the two modules be equal or different, depending on the power requirement needs of the components in the expansion module 105b.

The microprocessor bus 255 is not exploited by the components of the expansion module 105b, and is simply passed through the expansion module 305b, by means of a bus 440 of a suitable number of signal lines, connected to the first group of pins of the input expansion connector 400 and to first group of pins of the output expansion connector 405; the microprocessor bus 255 is thus made available to further expansion modules through the output expansion connector 405.

It can be appreciated that, similarly to the expansion module 105a, the output expansion connector 405 of the expansion module 105b propagates and makes thus available to further expansion modules:

the unregulated supply voltage, coming from the base module 100;

the microprocessor bus 255, coming from the base module 100;

the 10/100BaseTX Ethernet bus 430f, connected to the Ethernet port 425e of the Ethernet switch 410 in the expansion module 105b.

The MII bus 220 and the enable/disable line 257 for enabling/disabling the physical layer transceiver 210, coming from the base module, stop at the level of the expansion module 105a, and are not propagated to further expansion modules; the corresponding pins of the output expansion connector 405 are left unconnected.

Optionally, a low computing power microcontroller 455 may be provided in the expansion module 105b for locally managing the switch 410 through a management port 457 thereof. If provided, the microcontroller 455 may communicate with the data processing unit 200 of the base module through the bi-directional serial communication line 265; in this case, a first bi-directional serial communication line 460 connects a first bi-directional serial communication port 465 of the microcontroller 455 to the sixth group of pins (pin #67) of the input expansion connector 400. The data processing unit 200 in the base module 100 can thus communicate with, coordinate and control the microcontroller 455 in order to propagate the bi-directional serial communication channel to further expansion modules, a second bi-directional serial communication port 470 of the microcontroller 455 is connected, through a second bi-directional serial communication line 475, to the sixth group of pins (pin #67) of the output expansion connector 405.

FIG. 5 schematically shows a third type of expansion module 105c, according to an embodiment of the present invention. In particular, as mentioned in the foregoing, the expansion module 105c is intended to enable wireless communication of the gateway 160 with user appliances, for example the personal computer 130, shown in FIG. 1, or connecting the gateway 160 to an already existing wireless local network, or setting up a wireless local network.

The input expansion connector and the output expansion connector of the expansion module 105c are identified by reference numerals 500 and 505, respectively.

The expansion module 105c comprises a standard PCMCIA connector 510, accessible from outside the housing of the expansion module and adapted to receiving a commercially-available PCMCIA wireless LAN adapter card 515; examples of commercially available PCMCIA wireless LAN adapter cards are the Air DWL-650 by D-Link, the Wpc-0100 by Levelone, the I-Fly by Atlantis, the MA301 by Netgear. The pins of the connector 510 are connected to a signal line bus 520, connected to the first group of pins of the input expansion connector 500, reserved to the microprocessor bus 255; the bus 520 is also connected to the first group of pins of the output expansion connector 505, for rendering the microprocessor bus available to further expansion modules.

Through the microprocessor bus, the data processing unit 200 in the base module 300 can thus communicate with a wireless LAN, controller embedded in the adapter card 535.

A pair of lines 547 is connected to the fifth group of pins of the input expansion connector 500 and to the fifth group of pins of the output expansion connector 505. The unregulated supply voltage, received from the base module 100, is thus made available to further expansion modules. The unregulated supply voltage carried by the pair of lines 547 is fed to a voltage regulator 550, generating a suitable regulated supply voltage (e.g., 3 V or 5 V); a regulated supply voltage rail VCCc and a reference voltage rail GND are connected to prescribed pins of the PCMCIA connector 510.

The MII bus 220, the 10/100BaseTX Ethernet connection bus 230, the enable/disable line 257 of the physical layer transceiver 210 and, if present, the bi-directional serial communication line 265 are not used or handled by the expansion module 105c; the second, third, fourth and sixth group of pins of the input expansion connector 500 are simply connected to the corresponding groups of pins of the output expansion connector 505, through respective signal lines or buses of signal lines 525, 530, 535 and 540.

From the preceding description, it can be appreciated that two classes of expansion modules can be identified: expansion modules including one or more components controllable through a standard media independent interface (MII), for example the expansion modules 105a and 105c, and expansion modules not including such components, for example the expansion module 105c. In the expansion modules of the second class, the MII bus is not exploited, and is simply propagated from the input expansion connector to the output expansion connector. Differently, in the expansion modules of the first class, the MII bus is not propagated to the output expansion connector. The first expansion module of the first class that is added to the base module takes possession of the MII bus coming from the base module, and disable the physical layer transceiver in the base module; the MII bus is not made available at the output expansion connector. Nothing prevents from adding more expansion modules of the first class, but in this case only the first added expansion module benefits of the MII bus, the remaining expansion modules communicating over the 10/100BaseTX Ethernet bus. For example, making reference to FIG. 1, the expansion module 105a benefits of the MII bus, while the expansion module 105b communicates with the other modules via the 10/100BaseTX Ethernet buses 403e and 330f, connecting the Ethernet port 420e of the switch 410 to the Ethernet port 320f of the switch 310.

Concerning the expansion module 105c, as well as any other expansion module that enables accessing an external network, security issues may arise. In particular, when communication with the external network is managed by the central data processing unit 200, as for example the communication over the ADSL channel 103, the risk of intrusion from outside into the user local network are limited. For better protection, a firewall can be set up, e.g., by a suitable software running in the data processing unit 200. On the contrary, in a case similar to that of the expansion module 105b, the connection to the external network through the optical channel is carried out through an Ethernet port similar to the ports exploited for connecting the local network devices. The risk of intrusion from outside into the user local network is thus high. To reduce this risk, the switch 410 may be configured to add suitable tags on top of data packets coming from the external network; data coming from the external network can in this way be always identified and, if desired treated differently from the data packets exchanged over the local network. A similar technique can be exploited for creating two or more separated local networks.

In addition to the three types of expansion modules previously described, several other types of expansion modules can be envisaged. A non-exhaustive list of the possible expansion modules that can be devised and added to the base module includes: a cable modem (e.g., DOCSIS) expansion module or an ISDN expansion module, to connect to an external network via a cable TV connection or an ISDN link; an optical LAN expansion module, for interconnecting user appliances via optical fibers; a voice over IP (VoIP) expansion module for the connection to a standard or ISDN telephone set, enabling voice communication through the ADSL communication channel or, if present, the optical communication channel; a video expansion module for the connection (e.g., analog connection) to a TV set, enabling video communication (e.g., video over IP) through the ADSL communication channel or, if present, the optical communication channel, for diffusion of video programs to the user premises (set top box) and/or video conferencing and/or video telephony; a power line transmission (PLT) expansion module allowing communication over the AC power distribution lines in the user premises; a home PNA expansion module; a Bluetooth expansion module; a cordless telephony expansion module; a universal serial bus (USB) expansion module, enabling connection to USB ports of personal computers, printers and the like; a video module, enabling the decoding of video signals a card reader expansion module, enabling interaction with a user card, e.g. a smart card, intended for example to store a user profile for configuring the gateway. Any type of home networking technology and access technology to the external network can be supported, by developing specific expansion modules.

The gateway according to the present invention has a modular structure that enables the user to expand the gateway functions starting from a basic set of gateways functions provided big the base module.

The base module and the expansion modules can be bought separately and at different times. The user may initially buy the base module, which provides the basic set of functions; the base module, being relatively simple in construction, may be reasonably cheap. The low price and the presence of essential functions only, without additional functions that the user may regard as unnecessary, are considered to be strong incentives to the purchase of the base module.

Depending on the specific needs, the user can improve the gateway functions by buying and adding one or more expansion modules. This can be done at any time, either at the time the base module is purchased, or at subsequent times, so as to upgrade the basic set of gateway functions.

The number of expansion modules that can be added to the base module is in principle unlimited. An advantageous aspect of this is that each expansion module may be designed to implement a relatively limited number of additional functions, and can thus be kept simple in construction and consequently rather cheap. The costs for setting up a gateway with a desired set of functions can thus be tailored on the user needs.

In other words, the user is always left free to pay for purchasing the specifically needed functions, and not for functions that are not regarded as useful.

Developments in the access technology to the external network as well as developments in the local networking technology can be tracked by simply designing new expansion modules, that the user is free to purchase to update the gateway.

Another advantage of the gateway according to present invention resides in the peculiar power supply management. Each gateway module has an individual power supply management, being equipped with one or more respective power supply regulators, generating the regulated voltage(s) required by the electrical components of that module. Only the unregulated power supply is distributed to the expansion modules. The delocalisation of the power supply management allows avoiding the need of providing a central, overdimensioned power supply regulator in, e.g., the base module, intended to supply power to all the possible expansion modules that can be added. Delocalised power supply management is also advantageous because each expansion module may in principle have peculiar supply voltage requirements: it would be impractical, not to say impossible, to provide a central power supply management adapted to satisfy every possible power supply requirement of the expansion modules. Delocalised power supply management allows keeping the cost of the base module limited.

Although the present invention has been disclosed and described by way of some embodiments, it is apparent to those skilled in the art that several modifications to the described embodiments, as well as other embodiments of the present invention are possible without departing from the scope thereof as defined in the appended claims.

For example, in the embodiment of the invention described herein, the base module has only one expansion connector. However, nothing prevents from having more than one expansion connector; for example, the base module may have two expansion connectors.

The base module may also comprise a USB interface. Additionally, the base module may be equipped with a card reader for interacting with a user card, e.g. a smart card intended to work as a user subscriber card to specific services made available through the external data communication network.

In an alternative embodiment of the invention, the optional bi-directional serial communication line also includes address lines through which the data processing unit 200 in the base module 100 can address the microcontrollers in the expansion modules. For example, the single bi-directional serial communication line may be replaced by a serial communication signal line bus, such as an I2C bus, and a respective address be assigned to each expansion module; some, e.g. two, of the lines of the serial communication bus are for example used to assign the respective address to the expansion module to be added to the stack of gateway modules; the added expansion module reads the address assigned thereto and generates, for example on an incremental basis, a new address to be assigned to the next expansion module which will be added.

1-21. (canceled)

22. A modular expandable apparatus comprising at least one base module, the base module comprising:
a broad-band data communication device for handling communications with an external data communication network through a broad-band data communication channel;
at least one local network port for the connection to a local data communication network;
a local network interface device adapted to handle communications with the local data communication network and coupled to the local network port through a local network communication bus, the local network interface having a media independent interface and a disable input;
a data processing unit interacting with the broad-band data communication device and interacting with the local network interface device through a media independent interface bus connected to the media independent interface thereof, for enabling intercommunication between the local network and the external network;
a disable signal line coupled to the disable input of the local network device and adapted to drive the local network interface device into a disabled state in which the local network interface device does not engage the media independent interface bus and the local network port; and
an expansion bus allowing expandability of the apparatus connecting at least one expansion module to the base module, the expansion bus comprising the media independent interface bus, the local network communication bus and the disable signal line.

23. The modular expandable apparatus of claim 22, wherein the local network is an Ethernet network, and the local network interface device comprises an Ethernet physical layer transceiver.

24. The modular expandable apparatus of claim 22, wherein the broad-band data communication device is an xDSL data communication device.

25. The modular expandable apparatus of claim 24, wherein the broad-band data communication device is implemented by the data processing unit.

26. The modular expandable apparatus of claim 22, wherein the base module further comprises a data processing unit bus connected to the data processing unit, the base module being part of the expansion bus.

27. The Modular expandable apparatus of claim 26, wherein the base module comprises at least one expansion connector connected and allowing access to the expansion bus.

28. The modular expandable apparatus of claim 27, comprising at least one expansion module, the expansion module comprising at least one input expansion connector matching the expansion connector of the base module.

29. The modular expandable apparatus of claim 28, wherein the at least one expansion module further comprises an output expansion connector matching the input expansion connector.

30. The modular expandable apparatus of claim 29, wherein the data processing unit bus, the media independent interface bus, the local network communication bus and the disable line is propagated from the input expansion connector to the output expansion connector of the expansion module.

31. The modular expandable apparatus of claim 29, wherein the data processing unit bus is propagated from the input expansion connector to the output expansion connector of the expansion module, while the media independent interface bus, the local network communication bus and the disable line are not propagated to the output expansion connector.

32. The modular expandable apparatus of claim 31, wherein the at least one expansion module comprises an expansion module including an Ethernet switch.

33. The modular expandable apparatus of claim 32, wherein the Ethernet switch comprises a media independent interface which, when the input expansion connector of the expansion module is connected to an expansion connector of the base module, interacts with the data processing unit through the media independent interface bus of the expansion bus.

34. The modular expandable apparatus of claim 33, wherein the expansion module drives the disable line to a disable state for disabling the local network interface device of the base module.

35. The modular expandable apparatus of claim 34, wherein the Ethernet switch comprises:
at least one first Ethernet port connected to a respective local network connector through a respective first local network communication bus;
a second Ethernet port connected through a second local network communication bus to the input expansion connector, for the connection to the local network communication bus of the expansion bus; and
a third Ethernet port connected through a third local network communication bus to the output expansion connector.

36. The modular expandable apparatus of claim 32, wherein the Ethernet switch includes at least one optical Ethernet port connected through a respective optical Ethernet communication bus to an optical transceiver of the expansion module.

37. The modular expandable apparatus of claim 29, wherein the at least one expansion module comprises a wireless local area network expansion module.

38. The modular expandable apparatus of claim 29, wherein the at least one expansion module comprises a power line transmission expansion module adapted to allow communication over an AC power line.

39. The modular expandable apparatus of claim 28, wherein the base module comprises a power supply input for receiving an unregulated power supply, and at least one first power supply regulator for generating a first regulated power supply from the unregulated power supply, the first regulated power supply supplying the data processing unit and the local network interface device, and in which the expansion bus comprises unregulated power supply distribution lines, the at least one expansion module comprising at least one respective second power supply regulator generating a second regulated power supply from the unregulated power supply.

40. A method of expanding a modular apparatus adapted to allow intercommunication between a local data communication network and an external data communication network, the modular apparatus comprising a base module comprising:
a broad-band data communication device for handling communications with the external data communication network through a broad-band data communication channel;
at least one local network port for the connection to a local data communication network;
a local network interface device adapted to handle communications with the local data communication network and coupled to the local network port, the local network interface device having a media independent interface; and
a data processing unit interacting with the broad-band data communication device and interacting with the media independent interface of the local network interface device for enabling intercommunication between the local network and the external network,
the method comprising:
coupling to the base module at least one expansion module including at least one expansion local network port for connection to the local data communication network, and an expansion local network interface device coupled to the expansion local network ports and having a media independent interface;
disabling the local network interface device of the base module;
controlling the expansion local network interface device by means of the data processing unit of the base module through the media independent interface of the expansion local network interface device; and
coupling the at least one local network port of the base module to the expansion local network interface device.

41. An expansion module for the modular expandable apparatus of claim 22, comprising:
an expansion local network interface device adapted to handle communications with the local data communication network, the expansion local network interface device having an expansion media independent interface;
an expansion media independent interface bus connected to the expansion media independent interface;
an expansion local network communication bus connected to the expansion local network interface device; and
an expansion bus connection scheme for the connection of the expansion module to the expansion bus, the expansion bus connection scheme being adapted to:
connect the expansion media independent interface bus to the media independent interface bus of the expansion bus;
connect the expansion local network communication bus to the local network communication bus of the expansion bus; and
drive the disable signal line of the expansion bus to a state corresponding to a disabled state of the local network interface device.

42. A local communication network allowing user appliances to interconnect, comprising a modular expandable apparatus according to claim 22.
